(19) United States
(12) Patent Application Publication
(10) Pub. No.: US 2003/0200137 A1
(43) Pub. Date: Oct. 23, 2003

(54) Novel system and method for polling a group

(76) Inventor: Jill A. Drummond, Washington, DC (US)

Correspondence Address: PIP Consulting, 4326 Southern Avenue, S.E., Washington, DC, 20019, US

(21) Appl. No.: 10/378,946

(22) Filed: Mar. 5, 2003

Related U.S. Application Data
(60) Provisional application No. 60/361,359, filed on Mar. 5, 2002.

(51) Int. Cl. G06F 17/60

(52) U.S. Cl. 705/12

(57) ABSTRACT

The present invention is a forum comprising a telecommunications, web, and paper based technology in which individual member users of the system and client organizations linked to the network system through websites of the system are invited to respond to polls or surveys by entry to the web site, as well as receive and respond to educational information, message board discussions and other related services. The system shares and gathers information in a simplified, secure, and accurate fashion. The web-site offers a message board discussion process for individual member users to correspond with each other and legislators. Individual member users also receive information to purchase products offered by socially conscious companies and to link to those companies directly. The forum of the present invention provides telecommunication software, hardware and ongoing service to citizens and representatives and employee/members of corporations, schools, institutions, special interest groups, faith-based organizations and political parties, without regard to political preference. More specifically, the forum of the present invention operates within the political and business polling industry.

### BACKGROUND OF THE INVENTION

1. Field of the Invention

The invention relates to a system and method for polling a group with regard to political and educational issues. More specifically, the present invention relates to a method and apparatus for automating the conduct of surveys over a network system regarding political and educational issues in a politically tolerant fashion, thereby promoting equality of opinion.

2. Description of the Related Art

The United States was founded upon the principles of democracy and representative government. In a representative democracy, the government, comprising the people's representatives, responds to the will of the people as manifested through democratic forums in which the people can make their voices heard. However, the reality of American politics and education has often fallen short of these ideals. In some instances, pollsters and politicians construct flawed polls which provide support for a preordained poll result that does not represent the voice of the people. In other instances, politicians are afraid to rely upon polling data because it may be tainted or skewed. In other instances, the will of the people as manifested through democratic forums is not available in a thorough, politically tolerant fashion. This has resulted in a loss of confidence by the American people in their government.

Further, as a result of the recent attacks of September 11 on the United States there is an increased need for a forum to allow people from all walks of life and political preferences to become better educated and to register their opinions on topics affecting their future.

Several companies serve clients through the creation and analysis of multiple use polls. These companies include Interpol, Survey Crafter, Opinion Power, Ntercept Communications, The International Voting Center, Electronic Surveys, Working Assets, Form Site, Insight Express, and Apian Software, CNBC Polling, Roper, Harris Polls, Gallup Polls, National Rifle Association and other special interest groups. Although these companies provide polling services for general or specific use, they do not collect and communicate opinions from all population groups in a politically diverse and/or unweighted and weighted broad-based fashion, accepting any and all political preferences.

In addition, before proceeding with a particular service, strategy, or tactic, it is often desirable to obtain information about the behaviors, opinions, and attitudes of the citizenry, and include educational information prior to and/or proceeding the execution of a particular tactic. These data will often help predict if citizens or participants will be satisfied with a proposed service or how they may react to a given strategy or tactic.

Research plays an important role in understanding the current and future wants, needs, and behaviors of the citizenry/participants. As a result, many companies invest a significant amount of money, time, and resources in participant research programs.

Typically, if someone (a “client”) requires a better understanding of the market place, they will obtain information using an in-house market research department, an out-of-house third party market research firm, or both.

To obtain the requested information, individuals within research groups typically perform a series of linked steps. For example, these steps may include: (1) working with the client to define the problem; (2) designing a research instrument (i.e. a survey); (3) creating the research instrument (writing/producing the survey); (4) fielding the instrument using mail, telephone, in-person or Internet-based media; (5) processing the data obtained and analyzing the results; and (6) generating a report of findings for the client.

In defining the problem, a client generally specifies a set of parameters that defines the information the client needs to know, a particular target group of interests, a time frame, and a cost for the conduct of the research. For example, a client may want to know within three weeks, the flavor of toothpaste that is most liked by kids between the ages of six and thirteen.

Understanding the needs of the client, the market research professional or company develops a research solution to obtain the necessary information within the client's given constraints. The research solution typically involves a series of steps that may include creating a survey instruments and fielding to several hundred people by phone or mail to better understand the needs, behaviors, attitudes and opinions of the client's targeted group.

In general, market research is conducted using one or more of the following communication media: (1) mail, (2) telephone, (3) in-person, and (4) networks including the Internet, e-mail and the World Wide Web.

Using the first method, the research group mails surveys to a predetermined number of people who fall within the target group. This method of surveying includes such steps as printing surveys, addressing envelopes, stuffing envelopes with the survey, depositing surveys into a mail system, and then waiting for the target group to mail back responses. Once the responses are received, they are processed, coded, and entered into a computer to be analyzed. The analyzed data is then interpreted and reported back to the client.

A drawback associated with conducting research using mail is that it generally takes eight to twelve weeks from the time a project is initiated to its completion. In many cases, this delay is prohibitively long and unacceptable in today's competitive market where business decisions often have to be made in days—not weeks. In addition, the cost of producing, printing, and mailing surveys as well as analyzing the results of the survey can impose a substantial financial burden on many clients.

One approach to reducing the excessive delays that are inherent with mail surveys is to conduct surveys using telephone services. Conducting surveys via the telephone service minimizes the delays associated with mail, but the cost of hiring quality interviewers makes telephone surveying very expensive, thus imposing a substantial financial burden on many clients.

A third medium used for collecting survey data is in-person interviewing. As with telephone, the cost of in-person interviewing can be extremely costly, thus imposing an even higher financial burden on many clients.

A fourth and emerging medium for conducting research is the Internet and other networks. While they offer advantages of speed and lower costs, they reach a small percentage of the consumer and business public (approximately 25% of households and 30% of business) making it difficult to cost effectively find and interview targeted consumers and customers.

Finally, the time and cost of conducting research are often increased by the number of people and steps involved in the traditional research processes. Clients must often work through time consuming and expensive research bureaucracies; engage outside specialists or resources; find targeted respondents; and then wait for surveys to be created, fielded, and processed. The long sought after ideal of having decision makers be in close and timely contact with their citizenry/participants is thwarted by traditional systems, methods, organizations and norms.

It is clearly desirable to provide mechanisms and processes that decision makers and researchers alike can use to both quickly and economically reach out and understand the behaviors, opinions and attitudes of consumers and customers and provide educational information to them in today's competitive and fast moving market place.

Thus, there remains a need for forums in which people are empowered through telecommunications, web, and paper to raise their voices and enable the democratic process, such that the forum educates, collects and communicates the opinions of the nation in a politically tolerant fashion.

### BRIEF SUMMARY OF THE INVENTION

The present invention is a forum comprising a telecommunications, web, and paper based technology in which individuals are invited to receive information, provide demographic statistical data and responses, respond to polls through the telephone, paper, or by entry to the web site. Individual citizens may access the invention of the present application through a general member site and respond to topics of interest, or through special interest groups, colleges, associations, or corporations linked to the system of the present invention. The system will share and gather information in a simplified, secure, and accurate fashion. The web-site will offer a message-board format for participants to correspond with each other and legislators, as well as purchase products offered by socially conscious companies.

In one preferred embodiment of the present invention, the individuals are 18 years or older. In another preferred embodiment of the present invention, the individuals are younger than 18 years old. In a third preferred embodiment of the present invention, no distinction is made among individuals in the basis of age.

The forum of the present invention will provide web-, direct mail-, and telecommunication-based hardware and software and ongoing services to eligible voters, and employees/members of corporations; institutions, centers of learning, including schools and colleges; special interest groups; and faith-based organizations, tolerating all political preferences. More specifically, the forum of the present invention operates within the political, educational, not-for-profit, and business industries.

At present, there is no organizing system that collects and communicates opinions from citizens directly or through organizations and from demographically defined population groups in a fashion that accepts all political preferences. A combination of hardware, software and systems will, for the first time, meet the needs of the population within the boundaries of a democratic and representative form of government while, at the same time, facilitate the growth and development of electronic government initiatives.

According to one aspect of the invention, a method and apparatus for automating the conduct of professionally structured surveys, rather than opinion polls, over a network system is provided.

According to the method, an automated survey mechanism causes an interface to be displayed to a client which allows the particular client to post educational information regarding a topic and then to define a survey. In response to the client interacting with the interface, a sequence of steps is automatically performed. The sequence of steps includes generating a survey based on information received over said network system from said interface; fielding and posting surveys available to all individual members of a particular client on the network system; gathering results of the survey; and providing the particular client with data that reflects the results over said network system, including posting survey results for respondents and other interested parties to review.

### BRIEF DESCRIPTION OF THE DRAWINGS

Features and advantages of the present invention will become apparent from the following description of an embodiment thereof, by way of example only, with reference to the accompanying drawings, in which:

FIG. 1 is a block diagram of a computer system upon which an embodiment of the invention may be implemented;

FIG. 2 is a block diagram of a computer system context; and

FIG. 3 illustrates a flow diagram for automating a survey over a network system in accordance with the present invention.

### DETAILED DESCRIPTION OF THE INVENTION

As of 2000, there were an estimated 206,000,000 eligible voters in the United States, with approximately 123,000,000 voters currently registered. In addition, there are 200,000 associations in the United States.

There is a serious question as to the motivations, breadth of information, and accuracy of data gathered by polling services and special interest groups. The health of the nation lies in the growth of the hearts and minds of its citizens. In a republican form of representative democracy, citizens have the right to receive information regarding topics of interest and to access to venues to communicate their opinions accurately and openly so as to include all viewpoints and political preferences. The forum of the present invention will communicate members'/users' opinions and viewpoints to other members, organizations and/or the government and media for review and discussion. Results will be disclosed in unweighted and weighted forms to include weighted versus the membership and the national average from self-selecting audiences. Results used for legislative purposes will help harmonize the balance of power between government and citizens, producing greater expressions of freedom.

Although a large percentage of private individuals and organizations express their opinions on important topics in small and unique settings, the bulk of the population feels powerless to affect change in small numbers. The forum of the present invention facilitates the politically-tolerant gathering, analysis, and disclosure of opinions from wide and diverse audiences, in a preferred embodiment to citizens 18 years of age or older, and in another preferred embodiment to individuals under 18 years of age. In another preferred embodiment of the present invention, no distinction among individuals is made on the basis of age.

The forum of the present invention is preferably the standard by which individuals, either directly or as members of organizations, enable the democratic process by expressing their opinions on topics, and have the results communicated to other members, organizations and/or the government and media in a manner tolerating all opinions and political preferences.

The forum of the present invention preferably provides information and polls on topics affecting political issues, member/user lifestyles, and organizational growth and development. Additionally, the forum will facilitate the communication of results by transmitting members'/user's opinions in a manner tolerating all opinions and political preferences.

In a preferred embodiment of the present invention the system collects polling information from a variety of sources by means of a primary website that is capable of spawning off affiliate websites. Each affiliate website will be in itself a standalone website, but will share common tools and databases with the main website. Each affiliate website will be hosted on its own domain and have its own administrators.

In one preferred embodiment the primary website will have static internal pages, a list of affiliates, a login page, a member signup component, a surveys/polling component, a newsletters/articles component, and an educational links component. The affiliate websites will have a dynamic homepage, a login page, a member signup component, a surveys/polling component, a newsletters/articles component, an educational links component, and a contact information component.

In this embodiment, each affiliate website can have its own design template. Thus, the system is designed to accommodate different design templates for each affiliate. This is accomplished, in one preferred embodiment, by identifying the primary website as affiliate 1. This affiliate number is special and is reserved for the primary site. A virtual mapping is created. This mapping points to the location of all design templates. Each affiliate will have two design files created for it. The first file will include all HTML elements above the main content area, including the navigation area. The second file will include all HTML elements below the main content area. The primary affiliate's database will also include information about which files belong to which affiliate. The requested domain will be used to look up the affiliate and decide which design templates to use. The names of the files will be stored in request scope variables: request.header_file and request.footer_file.

In one preferred embodiment the primary website has a number of static pages, including a homepage, an About Us page, a Why Participate? page, a Gifts page, a Press Section page, a surveys/polling page, a FAQ page, a Privacy page, and a Contact Us page.

In this preferred embodiment the primary website has a basic entry page to log into the website. The homepage will consist of some static display with a login box. Successful login will take the user to the static homepage. In this embodiment the user is presented with a number of fields, including a Username entry field, a Password entry field, an “I forgot my password” field, and a Submit field. This page will also preferably include a link to “signup”. Clicking the link goes to Membership Signup.

In one preferred embodiment a method is provided for members to get assistance logging into their account. Preferably, a person can be helped in one of two ways: (1) answer the security question or (2) get a new password sent to them via e-mail. Here, the screen will present two sections. The top section will ask the security question the user selected when he/she signed up with the site. Below that will be a checkbox that reads indicates “I don't remember . . . please email me a new password.” If they answer the question correctly, then they are logged in and a new password is presented to them on the screen AND emailed to them. If they select the checkbox, a new password is simply e-mailed to them.

When a new user first signs up, information will be collected about that person. This information preferably includes First Name, Last Name, Email Address, Address, Username, and Password. This information will be gathered by means of a form. The form will have two main steps. The first step will include the basic contact information about the user (first name, last name, address, etc). The following fields will be validated: Email—validated as valid email; State—validated by required use of a state drop-down. The second step will include the username and password selection. Any username selected in the step should be compared against the database to ensure uniqueness.

Additionally, a preferred embodiment of the present invention will allow a variety actions, including Insert a Member, Update a Member, Delete a Member, Select a Member, Login a Member, Logout a Member, Add Member to Site, Remove Member From Site, Display Form, Validate Form, Process Form, and Check Credentials.

In an additional preferred embodiment of the present invention, articles are presented on the websites. Preferably each article has the following attributes: Title, Search Keywords, Synopsis, Author Name, Author Email, Report Date, Image, Image Caption, and Text. It will be appreciated that within the articles there can be links to related content and that the viewing of articles can be tracked.

The present invention provides a simple interface to collect polling information from members of the website. Once a user takes a poll, he/she will not have the option to take the poll again, unless the poll is resubmitted by the client. Instead of a link to take the poll, there should be text that indicates that he/she have already taken the poll and the date when the poll will close. Since a user's demographics may change (when he/she updates his/her profile), the key demographic fields are stored with the answers to each question.

Selecting a poll exposes a popup window with the questions and the possible answers. Each question may only have one answer selected. Selecting an answer and hitting “submit” will record the answer and present a “thank you, close window” type of text.

The Survey/Polling application preferably permits the following actions: Insert a poll, Update a poll, Delete a poll, Select a poll, Insert a question, Update a question, Delete a question, Select a question, Insert an answer, Update an answer, Delete an answer, Insert a response, Display a question, and Display a poll.

The present system also provides a front-end display of the results of polls. Preferably results are only available for polls that are closed; access to open polls is denied.

In an additional preferred embodiment of the present invention, the system provides users with useful links to resources on the web. The display will be a single page of links with each category having an appropriate heading. If a category is deleted II and it contains links, then the links will invalid until they are reassigned to a category. Invalid links will not be displayed on the website. The links are created by the following actions: Insert a Category, Update a Category, Delete a Category, Select Category, Insert a Link, Update a Link, Delete a Link, Select a Link, and Display Links. It is preferred that the system can track click-throughs on the links.

The present system also preferably provides a way for visitors to find affiliate sites. Preferably this is an alphabetized list links to affiliate websites.

Additionally, the present system provides an entry page for the affiliates' websites. Preferably affiliate sites will have two homepages. The first will be an entry page into the second. No access will be granted to the second until the visitor is logged in via the first. The first affiliate homepage will be a login page with the same specification as the primary website's login page. The second will be a set of dynamic text from the affiliate profile and a list of recent news articles.

In a preferred embodiment of the present invention, citizens 18 years of age and older will participate in the forum. In this embodiment, individual members/users comprise all eligible voters. The institutional members/users include representatives of political parties, corporations, institutions, faith-based organizations, schools, colleges, universities, and special interest groups and their employees/members. It will be appreciated that the individual members/users, either directly using the system of the present invention or as institutional members, can be subdivided on a variety of bases, demographics and statistics, including economic status; city/state resident location; race; ethnic background; education; age; gender; religious affiliation; and membership in organizations such as AARP, NAACP, NOW, schools, universities, and similar organizations. Both of these member groups will be served, tolerating all political preferences and opinions.

In a preferred embodiment of the present invention, the availability of the forum is communicated to the nation by means of web, print marketing, direct mail advertising, radio and television appearances, and proprietary publications.

It will be appreciated that the forum of the present invention is not limited to the United States, but that such a forum would also meet democratic needs in the rest of the world.

In a preferred embodiment of the present invention, citizens may participate in the general member section of the system and facilitate the democratic process without charge. Additionally, citizens can also facilitate the democratic process by participating as institutional members.

In a preferred embodiment of the present invention, revenues will come from a variety of sources, including, but not limited to, organizational and/or institutional membership, annual individual membership, survey fees and sponsor/vendor participation fees.

In another preferred embodiment of the present invention, revenue streams are generated by purchasing the products and services offered to members/users through the forum system. Members preferably include individuals less than 18 years of age, eligible voters, representatives and employee/members of institutions, corporations, schools and universities, government agencies, political parties, special interest groups, faith-based organizations, and e-commerce providers. A secure personal user ID and password obtained during the registration process will provide security and prevent repeated responses to a survey by a member/user. Periodic announcements and a newsletter and will preferably educate participants on topics, provide surveys and guide users on the systems usage and efficiency.

In addition, the recap of hearings involving the forum members'/users' opinions and the active communication of their voices to other members, institutions, organizations, government, media and other interested parties enables the democratic process. Members will receive discounts on product purchases. The forum of the present invention preferably allows members/users from all walks of life and political preferences to register their opinions and viewpoints on topics affecting their future and/or the growth and development of their sponsoring organizations.

It will be appreciated that topics on the forum may include local, state, federal and international political issues and election information; tax law; health care; education; culture; environment; reproductive rights; gay rights; gun control; and pension reform; among others of substantial diversity.

In one preferred embodiment, nominal costs to become a member/user of the system through an institution or organization will be directly billed to users' credit cards, debit cards and/or check debits.

It will be appreciated that in a preferred embodiment of the forum of the present invention, target markets include eligible voters and representatives and members/employees of businesses, institutions, faith-based organizations, students, and special interest groups.

With regard to the eligible voters, this group has several critical needs. These include access to information on legislative issues affecting their lives; information on topics affecting the growth and development of their organizational affiliations; user-friendly access to information; easy access to results; an open forum in which to express opinions; political recognition of their opinions; legislative impact; accurate, simplified voting systems; and security and influence within group structure.

Although citizens have in the past been able receive access to information from various organizations, special interest groups, such as the NAACP and the AARP, results are targeted to specific platforms of the organizations. No prior organization represents all population groups and political preferences. The forum of the present invention will provide user friendly information and polls on topics affecting their lifestyles and human rights, and will facilitate legislative results by communicating members'/users' opinions in a politically tolerant way. In this manner, even a single voice is empowered and opinion results will be accurate, facilitate the democratic process, and promote change.

Although lobbying organizations currently represent certain industries or multiples industries concerning specialized issues, membership fees can range from $5,000 to $25,000 per year and polls or surveys are seldom incorporated to solicit member/user opinions from broad audiences.

With regard to special interest groups, these groups have critical needs, including Capitol Hill representation; results; and cost efficiency. Although existing special interest groups have infrastructures effective on Capitol Hill, they are not using their members and organizational viewpoints to tolerate and/or encourage other opinions and political preferences.

It will be appreciated that target markets of the forum of the present invention can preferably be identified through market research, census bureau, directories, documents/hearings, trade associations, special interest member lists, and advisory board affiliations.

It will also be appreciated that these target markets can be addressed through direct mail advertising, regional print marketing, radio and television, web, telephone/wireless, and proprietary publications.

Preferred strategies including political tolerance will facilitate success of the forum, including sales of weighted and unweighted poll results gathered by outside non-client organizations from approving individual members of client organizations; product sales offered through the forum web site offered by e-commerce alliances; and marketing efforts promoting repeat system usage.

In other preferred embodiment of the present invention, market research is conducted to target students and all voting groups and legislators for the marketing and public relations campaigns and grassroots support for the system is established on Capitol Hill. Additionally, certain results obtained from the forum polls are preferably sold and/or delivered to special interest groups, institutions, and the media. Results from the forum are also preferably presented to the Congress and other interested parties for review and discussion.

The forum of the present invention is a web-, telecommunications- and direct mail-based system enabling and standardizing the democratic process. Advertising and promotion to initiate usage include regional print based media, emotional appeals, mail marketing campaigns, dedicated website, direct mail and telecommunications support. From those efforts, the forum reaches out to hundreds of millions of U.S. residents, including United States citizens, resident aliens, and Native American populations to motivate the individuals to contact the forum by means of the web, telephone, cell phone and/or direct mail.

Preferably there is an annual fee charged to individuals seeking membership through an institution or organizational client. The annual fee is preferably charged to an individual's debit card, credit card or an individual may send a check or money order. The individual will select and receive a user ID and password, and the system will ask for statistical information to substantiate the necessary criteria in order to successfully conduct unweighted and scientific polling and the member/user may receive a complimentary gift. Members will participate in the system by receiving educational information, participating in message board discussions, responding to political polls and surveys, and receiving progress reports and results of their organization. In turn, these responding members/users receive poll results, proprietary newsletters, links to political legislative information, and receive audio, visual and direct mail recaps of legislative hearings communicating members'/users' viewpoints and results to the government.

A preferred result achieved with the forum of the present invention is that Client organizations, institutions, and members/users may purchase poll results. Non-client organizations and institutions may also purchase poll results and conduct polls from approving individual members. In addition, certain results are preferably communicated to legislators, media and other members. The survey results are politically diverse and tolerate all viewpoints, both unweighted and weighted, so that legislators and the medial will be able to clearly discern the voices of the nation relative to demographically defined unweighted and weighted data and the national average. This results in a circle of communication gathering, results generation and results recommunication.

The forum of the present invention permits citizens in this country to express their needs, their opinions and viewpoints and have it affect policy such that those that are elected to represent the nation can represent it accurately and fairly.

The poll results can preferably be distributed through e-mail and direct mail and members/users can receive poll results directly. In a preferred embodiment, the poll results are provided in a professional format to institutions, organizations, special interest groups, schools, universities, and legislators in print and/or electronic form and also disclosed to the media. In such a manner, the public can ascertain that the joint efforts of people expressing their viewpoints can affect policy and standardize the democratic process.

In a preferred embodiment, the present invention advantageously provides a way of asking a question of any number of self-selected users, preferably via electronic mail, direct mail or an equivalent communications media, and automatically receiving, identifying and processing responses to the question.

From a first aspect, the present invention provides a system for obtaining information from a plurality of computer users: comprising a processing apparatus including an input means via which a poll or survey author may input data, and a poll or survey authoring means enabling construction of a poll or survey questionnaire document including at least one question formulated from data input by the poll or survey author; transmission means for transmitting the poll or survey questionnaire document to a plurality of respondent users; and a processing apparatus including a collating means arranged to receive transmissions from the transmission means, to identify response documents which include responses to the at least one question from the plurality of respondent users and to load a database in accordance with the responses.

The transmission means is preferably electronic mail, web, and/or direct mail. Please note that the terminology electronic mail is not only used in a narrow sense, but used in a more general sense, to mean any way of communicating between computer users utilizing telecommunications media (telephone, optical fiber, satellite, etc.) which enables a user or group of users or a location e.g., a “relative” location such as a “bulletin board” to be designated by an address, preferably a unique address. The transmission means may even include transmission of floppy disks including the response document or by ordinary mail.

Where electronic mail is employed, the collator means is preferably arranged to monitor all electronic mail being received by the processing apparatus in which the collator means is included, to sort the electronic mail to identify response documents. Electronic mail not including a response document is not processed any further by the collation means. Where a response document is identified, further processing takes place. Preferably, the further processing includes locating the database which is to receive the responses to the poll or survey document, and loading the database in accordance with the responses.

In preferred embodiments, the apparatus and method of the present invention advantageously enables the member/user of a processing apparatus such as a computer or direct mail to prepare a poll or survey document asking members/users for information on any subject he desires, utilizing at least one question or any number of questions determined by the author, to transmit the poll or survey document to any number of remote processing apparatus, preferably by electronic mail, to receive and automatically collate response documents containing or specifying responses to the poll or survey document provided by members/users of the remote processing apparatus to which the poll or survey document is transmitted, and loading the database with answers, so that the answers are all conveniently presented in a database for subsequent analysis.

The invention preferably provides the ability to gather information very easily and quickly over vast distances and to automatically present the information in an already-collated and format. It can be used for any number of information gathering applications.

The information obtained by embodiments of this invention is preferably “fresh,” demographically delineated, from wide and diverse audiences, and represents feedback gathered from a few to dozens of questions relating to a single survey topic. It can be obtained very quickly and is therefore more likely to be relevant than information obtained by prior art methods, such as, but not limited to, opinion polling. Because the information is automatically processed and presented in a database, there is no need to undertake the laborious job of individually processing each response document. An immense amount of time can be saved. Because of the automatic collation, a single poll or survey author may attract thousands to millions of respondent users, their responses being processed for him/her automatically almost as soon as they arrive. It can be considered akin to the poll or survey author simultaneously having a “conversation” with thousands of people. Instead of the responses being a jumble of noise, as it would in a real life conversation with such a crowd, the user receives the information presented in an immediately understandable format of his/her choice.

The database used may be any type of computer data storage arrangement. It may be a relational database or series of databases of the type presently known. The database preferably includes a plurality of fields for receiving answers dictated by the responses. Each database field for an answer is preferably uniquely identified by a column label, which may relate to the question asked, and a “row” label which relates to the identity of the respondent user. The terms “columns” and “rows” are not used in any limited sense to indicate that all the databases are physically matrixes (although they can be represented that way), but to indicate that each answer field has a unique identifier. The unique identifier is not based on the respondent's responses. The column defines the field. The row is the record of the individual participating. One or more “columns” in the database may be required. The records have unique identifiers and the users have unique identifiers. The user identifier keeps every user unique.

Note that the possibility exists of allowing for more than one answer by the same member/user to the same poll or survey document. For example, a respondent user may be asked to answer the poll or survey document every week. To run the survey again, it should be re-entered on the system again.

The data base field values may be derived from the response provided by the respondent member/user or may actually be the response provided by the respondent member/user, for example, where the response is text information.

Once the database has been loaded with data, then the information can be viewed demographically in total, or per demographic category. Demographic categories may include state, zip code, age, age range, among others.

A particular advantage of using e-mail is that it is possible to store the address of respondent users in the database, for later use. It would then, for example, be possible to e-mail “calls to action” to members requesting their voluntary participation. Using the properties of databases an initial poll may be posted for response, be posted a second time, or be amended very quickly. Certain demographic groups of members could be invited to respond again to a prior or revised survey. This illustrates the “conversational” advantages of at least preferred embodiments of this invention, as discussed previously. It is possible to obtain responses from people in a very short time period and use the information from those responses to ask further questions.

The system therefore preferably has the ability to mail to respondents of previous poll or surveys, to facilitate this “conversational” style of communication. Note that the process of “conversation” may be particularly important when the analyzed data shows a trend that the poll or survey author did not expect and did therefore not include any questions to cover this eventuality. He can produce further poll or survey documents to send to the respondents including those questions that he did not include in the first place. Conversation is further facilitated by the ability to choose which respondents to mail to, may be depending upon their responses to previous questions, combined with the ability to store electronic mail name and address lists of respondents.

The database is preferably created automatically by the poll or survey authoring means, preferably when the poll or survey document has been created and completed. It is not generally necessary for the user to input data specifically to prepare the surveys for the database, and a facility is preferably available to enable the user to choose labels for database columns and/or rows and other statistical means to retain and review survey results.

As the poll or survey author constructs the poll or survey document, the poll or survey preparation means is preferably arranged to allow labels for database columns to be inserted. If the user does not wish to insert any labels himself/herself, the poll or survey document preparation means is preferably arranged to select the headings itself, i.e., by default.

The system also preferably has the ability to track communication traffic patterns.

The database is preferably constructed as a matrix, having at least one question column and a plurality of user rows, the rows and columns specifying a plurality of database answer fields for receipt of answers (being derived from the respondent users responses) to the at least one question, each row being associated with a particular respondent user who may receive or has received the poll or survey document and may provide or has provided an answer document (response document). The question column is associated with the at least one question asked. It will be appreciated, as discussed above that the matrix format is preferred, but it will also be appreciated that the invention extends to cover any type of database structure.

The poll or survey questionnaire document or a subset thereof may be stored to enable re-transmission of the survey document at a later stage, as a reminder should any of the pre-selected users not have provided a response document. The database is also preferably constructed just prior to transmission. Where the respondent user identities are known the entire database may be constructed (pre-populated).

It will be appreciated that the option does exist of constructing a database as answer documents are received and processed, e.g., a particular user row will only be added when an answer document is processed. This embodiment may have applications where, for example, the poll or survey document is posted on a “bulletin board” for use by any persons who wish to answer the poll or survey. Each row or row label will therefore only be added as responses come in and are processed by the collation means. The response document preferably includes an identifier identifying the database survey it belongs to, so that the collation means can load the appropriate database with the response and construct a further row label.

The use of electronic mail enables selection of any type of user, group of users, posting on a bulletin board, among others.

By “user” is meant any citizen or group of citizens, or generally an “identity” that may be specified by the poll or survey author. A responder user is also known as a member or member/user. A client can be an institution, organization, corporation, faith-based organization, political party, school, or university using the system of the present invention through a dedicated website linked to the system.

The poll or survey document may be saved on the system enabling the organization conducting the survey to send responses back to the collator when and as often as desired. This could be useful in any circumstances where data is collected on a regular basis.

The poll or survey document may include any number of questions and may also include branched-to questions linked to another question or questions such that the branched-to question or questions will only be required to be answered by a respondent user if the respondent (remote user) user gives a predetermined answer to the question or series of questions to which the branched-to question is linked. A poll or survey document may include a string of questions linked to each other and the branched-to question or questions may be asked if the remote user has given one or more predetermined answers to the string of questions and to the question to which the branched-to question is linked. In a preferred embodiment, the poll or survey document is presented to the respondent user as a plurality of screens (where there are a plurality of questions), each screen asking, generally, one question. A screen presenting a branched-to question will not be presented by the display to the remote user unless he makes one or more predetermined answers to a previous question or questions. Whether a branched-to question is presented may also depend on whether another or other questions have been presented or will be presented to the remote user (respondent user). In other words, if the respondent user's answers have meant that he has “bypassed” a question or questions, then a particular branched-to question may be presented. Note that it is also possible to ask a number of questions on a single screen and whether a particular question is presented may depend on his/her answer or combination of answers to any one or more of these questions. The poll or survey document in this preferred embodiment is “dynamic”, in the sense that it will only present questions to a respondent user if the respondent user has made a predetermined answer or answers to a linked question or questions. The survey document will guide the respondent user on a path through the document which is determined by the respondent user's answers. Questions which are not relevant to the respondent user, as determined by his/her answers to other questions, will never be asked of the respondent user. This has the advantage that it is not necessary for the respondent user to wade through a series of displayed questions to find the ones that are relevant to him/her. He will be automatically guided through the document. It saves time.

The poll or survey authoring means preferably includes a branch control means which enables construction of a complex linked survey document structure on the basis of data input by the survey author. The branch control means includes branch control operator commands which are selectable by the survey author to govern the link structure. These are tools which the survey author can use to construct a complex document with many pathways through it.

Preferably, the step of preparing the poll or survey document includes specifying an allowable answer or a plurality of allowable answers to the at least one question, so that remote users of may specify at least one of the allowable answers, when processing the poll or survey document on their computer(s). Preferably, a database field value is specified for each allowable answer. In a preferred embodiment, when the answer document is processed, the database field value is entered in the appropriate database field.

The field value may be comprised of numeric or alphanumeric characters may be any desired symbol or symbols. In a preferred embodiment, the specified field value for a particular question may be generated automatically from components of the question itself, components of the allowable answer, or may be an automatically generated default.

The allowable answers in some cases may be text to be inserted by the respondent user. In these cases, a length for the allowable text may be specified by the poll or survey author. The database field value will be whatever text the respondent user inputs, within the allowable field length. This allows for anything from simple answers to more complicated text answers.

Where a question or questions is not asked of a particular user, i.e., it may have been bypassed because the users responses to other questions in the poll or survey document meant that it was not appropriate for him/her to be asked that question or questions (see above) then, preferably, a “never seen” value is entered in the appropriate database field on collation.

The person accessing the database can therefore see at a glance whether or not a particular user actually “saw” a particular question. The never-seen value may include any choice of character or group of characters and may be specified by the poll or survey author or as a default by the poll or survey document preparation means.

The step of preparing the plurality of allowable answers may include preparing a grid, having rows and columns providing a matrix of cells for receiving the allowable answers. A title head is preferably prepared for each row and column in the matrix.

In a preferred embodiment, there are three types of grids which may be applied. An option buttons grid, a numeric field grid and a check box grid.

For an option buttons grid only one question column is generally required in the database even though there may be a plurality of cells in the grid for receiving the allowable answers. Preferably, the field values associated with each allowable answer are taken from components of the row and/or column heading for each particular cell. Option button grids may also be provided including sub-groups of option buttons each requiring an answer. In this case, there will be as many question columns in the database as there are groups of option buttons requiring an answer. The groups are preferably in rows and columns.

For numeric field grids and check box grids, in the preferred embodiment a question column in the database is required for each cell of the grid. The headings of these question columns may preferably be formed from components of the row and/or column head of the grid.

Preferably, the step of preparing the poll or survey document further includes the step of scanning the poll or survey document when it has been completed by the author and identifying any errors in the question structure, utilizing a scan test means included in the processing apparatus including the poll or survey authoring means. Generally, each question in the poll or survey document must come from at least one previous question and lead to at least one further question, apart from the first and last questions in the poll or survey document which will come from the start of the document. (Please note each question will be designated by the affiliate client organization and/or founding organization. In fact, in the preferred embodiment, it is open to the affiliate client organization and/or founding organization to formulate the questions first and then designate their sequence in the structure of the document separately) and lead to “finish,” respectively. In a complex document including branched-from and branched-to questions there will be a number of different “pathways” through the poll or survey document. It will be appreciated that the structure can be extremely complex. It is quite possible that during preparation of the poll or survey document, the user (the poll or survey author) will make an error in preparation which will lead to one or more of the pathways being incomplete or broken, i.e., a question exists (other than the first question) which does not come from any other question (an “orphan”) or which does not lead from all the questions it is supposed to lead from, and questions may exist which do not lead to any other question (“cul-de-sacs”) or do not lead to all the questions they are supposed to lead to. Any such errors should be identified before the poll or survey document is transmitted. This is preferably done by applying a scan test function, which scans through all the pathways in the document to identify errors, particularly of the “orphan” or “cul-de-sac” type, although it may identify other “mechanical” errors of this type which may lead to breakdown of pathway in the poll or survey document. The scan test means applying the scan test function will also test for missing, duplicate and illegal database names (for example, the database name not allowed by the particular database which is being constructed, for example, in DOS only eight characters are allowed for a database name).

The scan test function preferably also provides a display listing of all the variable information in the poll or survey document, variable information generally being any item in the document that the local user may exercise a choice in selecting, for example, “Goto's”, whether the question is branched to or not, database field titles, etc., but does not display, in general, any textual information from the question content of the poll or survey document. The listing enables the local user to check that the mechanical structure of the document (the pathways leading through the poll or survey document) is correct, by visually checking the listing. Further, in one embodiment, the items in which errors have been identified are indicated in the listing, preferably by highlighting these particular items. By clicking on any of the items on his/her screen the local user will automatically be taken to the actual item. It is therefore possible for him/her to easily be able to check the document and correct any errors indicated.

In a preferred embodiment, the steps of preparation of poll or survey questionnaire document, transmission, processing of the poll or survey document by a respondent user (remote user) return of the poll or survey document to the collation means and collator, operate as follows:

A survey master document is originally constructed and includes operator commands for controlling the display of the respondent user's computer to display questions, and, in response to the remote users input, to display selected ones of the questions depending upon the linkage structure of the document. The database is constructed from instructions input by the poll or survey author and/or defaults. The poll or survey questionnaire document (preferably a subset of the master) is transmitted and at the same time saved so that reminders can be transmitted if required (note the poll or survey document is preferably transmitted as a “subset” SVQ, of the originally prepared master, sum, and it is the SVQ which is stored). In one preferred embodiment, the poll or survey document is transmitted with respondent control means, used to control the respondent's terminal to run the poll or survey document. In an alternative embodiment, a respondent control means is pre-loaded on the respondent's computer, and is arranged to control the respondent's terminal to process a poll or survey document when one is received. At this time the database is preferably constructed.

The respondent user's terminal allows the respondent user to process the poll or survey document and produce responses based on data input by the respondent user. The poll or survey response document may include a database construction means which enables construction of the database. This is useful where a disaster has occurred and the database has “crashed”, for some reason. It may also be useful where the collator has moved location and does not have access to the database or does not know the database's address.

The collation means monitors responses at the processing address including the collation means and identifies responses. It checks the identifier including the response document to identify the database it belongs to. It then locates the appropriate database and commences to process the poll or survey document to load the database with answers determined by the respondent user's responses. Note that the collation means and poll or survey author may be on separate processing apparatus. The poll or survey author may also be a different person from the person who is accessing the database to obtain the information. For example, the poll or survey author may be a pollster employee, and the person accessing the information may be the pollster. The poll or survey author can put together the polls or surveys on the basis of instructions provided by the pollster as to what type of information he wants. All the poll or survey author needs to know about the collation means is the collation means electronic mail address. The database may be loaded on the same processing apparatus as the collation means or on any other processing apparatus.

The collation means may be collating any number of polls or surveys. It may collate polls or surveys for any number of survey authors.

The response document may be encrypted for security reasons.

Preferably, the collation means is also arranged to identify specified user ID numbers and passwords of respondent users and responses and attached messages and to load the database with the responses.

Where a range of databases are used, a great deal of information can be obtained over time about a particular respondent user who has received a number of polls or surveys.

All “documents” are preferably in “data processing representation” form. In other words, they are in an electronic or other form able to be manipulated by a data processing apparatus, e.g., a computer, and, in some aspects, to control a computer. By “computer” is meant any processing apparatus which is able to manipulate data. This includes computers which use other means apart from electrical signals to process data.

From a second aspect, the present invention provides a processing apparatus for enabling construction of a poll or survey questionnaire document, comprising an input means via which a poll or survey author may input data, a poll or survey authoring means enabling construction of a poll or survey questionnaire document including at least one question formulated from data input by the poll or survey author and a location address of a processing apparatus including a collator means arranged to collate response documents produced by respondent users processing the poll or survey questionnaire document.

The poll or survey authoring means may include any or all of the features of the poll or survey authoring means discussed above, for preparing a poll or survey document with any or all of the features of the poll or survey document discussed above.

From a third aspect, the present invention provides a poll or survey questionnaire document structure, the document being employable by digital document processing systems to gather information from a plurality of respondent computer users, the document structure including: a location address for a collation means for receiving response documents to the polls or survey questionnaire document from respondent users; and instructions enabling control of a computer to display one or more questions to be answered by a user.

From a fourth aspect the present invention provides a processing apparatus for collating response documents received from a plurality of respondent users in response to their receiving a survey questionnaire document from a processing apparatus, including a collator means arranged to monitor incoming transmissions from a transmission means and identify response documents, which include responses and to load a database in accordance with the responses.

From a fifth aspect the present invention provides a processing apparatus for receiving and processing poll or survey questionnaire documents produced by an apparatus, including a respondent control means arranged to process the poll or survey questionnaire document in accordance with data input by a respondent user, to produce a response document including a response to the at least one question.

From a sixth aspect the present invention provides a computer-readable memory including a set of instructions for enabling a processing apparatus to enable construction of a poll or survey questionnaire document, the document being employed to gather information from a plurality of respondent users, the instructions enabling the computer to operate as a poll or survey authoring means enabling construction of a poll or survey document including at least one question formulated from data input to the computer by a poll or survey author, and a location address for a collation means for receiving and collating response documents respondent users in response to their processing the poll or survey questionnaire document.

From a seventh aspect the present invention provides a computer-readable memory storing a set of instructions that can be used to direct a processing apparatus to operate as a collator means, for collating response documents in response to a poll or survey questionnaire document produced by a processing apparatus, the instructions operating the processing apparatus to monitor incoming transmissions for response documents, and to load a database in accordance with responses.

From an eighth aspect the present invention provides a computer-readable memory storing a set of commands that can be used to direct a processing apparatus to process a poll or survey questionnaire document produced by the apparatus, to produce a response document including a response to the at least one question, to be transmitted on a location for a collation means for collating responses.

From a ninth aspect the present invention provides a method of obtaining information from a plurality of computer users, comprising operating a processing apparatus including an input means via which a poll or survey author may input data, to construct a poll or survey questionnaire document including at least one question formulated from data input by the poll or survey author, transmitting the poll or survey document to a plurality of respondent users, and controlling a processing apparatus to carry out a collation operation including the steps of receiving transmissions from respondent users, identifying response documents including responses from the plurality of respondent users, and loading a database in accordance with the responses.

The tenth aspect of the present invention provides a method of controlling a processing apparatus to construct a poll or survey questionnaire document for obtaining information from a plurality of respondent users, the method comprising the steps of: controlling the processing apparatus to construct a poll or survey questionnaire document including at least one question formulated from data input to the processing apparatus by a poll or survey author; and to include a location address of a processing means for collating responses to the poll or survey from respondent users to load a database in accordance with the responses.

The eleventh aspect of the present invention provides a method of collating response documents prepared by respondent users in response to a poll or survey document, the method comprising the steps of: controlling a processing apparatus to monitor incoming transmissions to the processing apparatus and identify response documents to the poll or survey, and to process the response documents to load a database in accordance with the responses to the at least one question.

Hardware Overview

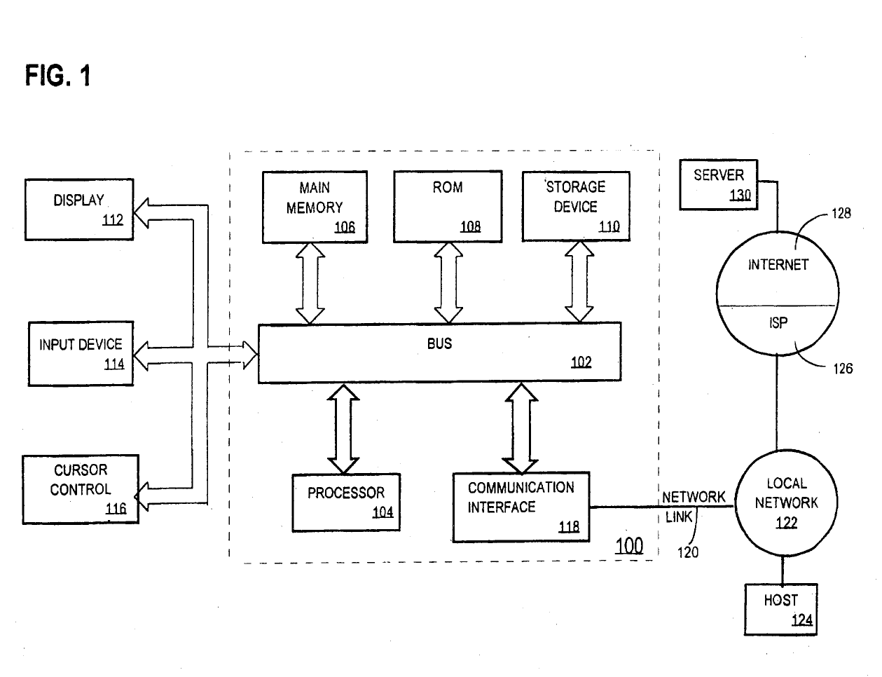

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The invention is related to the use of computer system 100 for automating surveys over a network system. According to one embodiment of the invention, the automation of surveys over a network system is provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for automating surveys over the network system as described herein.

The received code may be executed by processor 104 as it is received, and/or stored in storage device 110, or other non-volatile storage for later execution. In this manner, computer system 100 may obtain application code in the form of a carrier wave.

Functional Overview

In accordance with the present invention, an automated survey mechanism provides an interface that enables a client to define, target, field, and receive results from a particular survey. This interface typically consists of one or more individual interfaces that are provided to the client over the network system. In certain embodiments, the interfaces are provided using HTML page formats and are provided to the client via the Internet or other networks. In certain embodiments, the interface is presented to the client via Java Script, Applets, Word processors, or other software programs. By interacting with the interface, the client has the ability to define a particular survey, select the target audience for the survey, and define other pertinent parameters. Once completed, the survey is automatically created and fielded to a particular group of network users (target group or respondents) who are connected to the network system. Results from the survey are quickly and automatically gathered as network users (or respondents) complete the survey. The gathered results are automatically processed, analyzed, and data and charts that reflect the survey results are sent to the client.

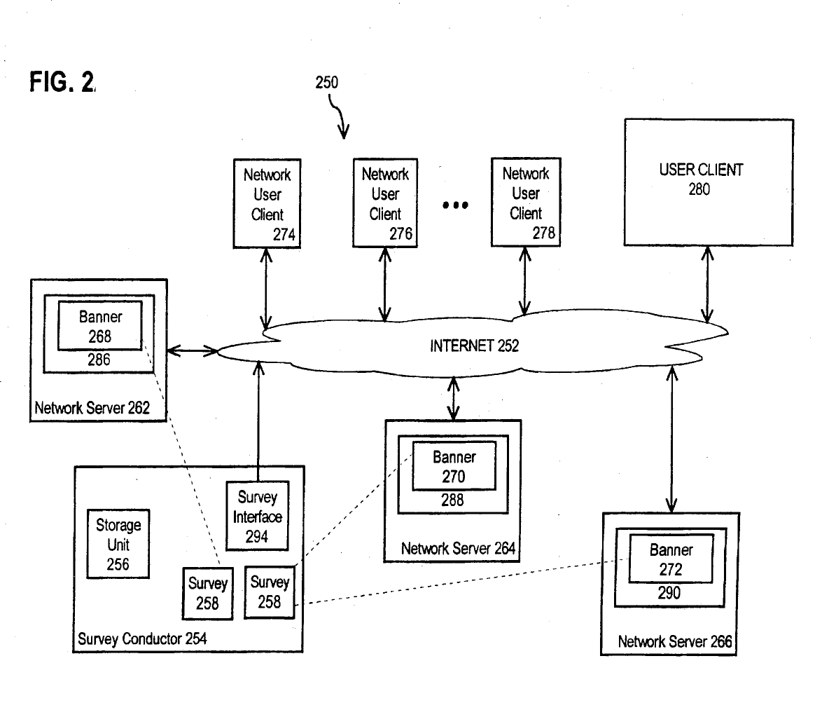

FIG. 2 illustrates in block form an example of the parties and systems involved in this context. In FIG. 2, a client 280 is coupled either directly or indirectly to the Internet 252. For example, a client 280 may be connected to Internet 252 through a local area network, an Internet Service Provider, an Online Service Provider such as AOL, a proprietary server, or any combination thereof. The user client 280, and the other clients referenced in this description, are end station devices such as a personal computer, workstation, network computer, etc. In the preferred embodiment, the client 280 and other clients have a processor that executes an operating system and a browser program under control of the operating system. The browser program is an industry-standard World Wide Web browser, such as Microsoft Internet Explorer, Netscape Navigator, or NCSA Mosaic.

Connected to the Internet 252 is a plurality of network user clients 274, 276 and 278. By interfacing with network user clients 274, 276 and 278, network users can access, display and interact with Web pages that are contained on servers that are coupled to Internet 252.

Through Internet 318, user client 280 and network user clients 274, 276 and 278 can connect to the survey conductor server 254. Preferably, client 280 and network user clients 274, 276 and 278 communicate with the survey conductor server 254 using industry-standard protocols such as Transmission Control Protocol (TCP), Internet Protocol (IP), and Hypertext Transfer Protocol (HTTP).

The survey conductor server 254 contains a survey builder 294, a storage unit 296 and a plurality of surveys 256, 258 and 260. Survey builder 294 contains interface data that defines an interface that can be used to create a survey. For example, if a client requests to define a survey, the survey builder 294 automatically sends interface data over Internet 252 to cause an interface to be displayed on the browser executing on user client 280. The client then interacts with the interface to create a survey. The plurality of surveys 256, 258 and 260 represent surveys that have previously been created using survey builder 294. Storage unit 256 is used to store survey results. As network users participate in the surveys, the results are automatically stored in the storage unit 296.

Also coupled to Internet 252 are network severs 262, 264 and 266 each respectively storing data that defines a set of Web pages 286, 288 and 290. The Web pages 286, 288 and 290 may be defined using a variety of methods and formats such as HTML, Java Script, Applets, Word processors, or other software programs. Contained within the set of Web pages 286, 288 and 290 are banners 268, 270 and 272 which may also be defined using a variety of methods and formats. As indicated by the dashed lines, the banners 268, 270 and 272 contain hypertext links to surveys 256, 258 and 260. By selecting a banner, a network user client is automatically provided with a corresponding survey.

Defining a Survey

When a client requests a survey be built, the client is provided with interface data that causes an interface to be displayed on the client's display unit (i.e. computer monitor, television set, etc.). Various mechanisms may be used to present the interface to the client. For example, the client may execute a locally-stored program that generates the interface, or a dynamically delivered JAVA Applet that generates the interface. For the purpose of explanation, embodiments of the invention shall be described in which the interface is delivered to the client in the form of one or more HTML pages. However, the present invention is not limited to any particular mechanism for presenting the interface to the user.

Once the client is presented with the interface, the client may interact with the interface to perform the steps of: (1) defining a survey; (2) identifying a target group of network users or respondents for fielding the survey, the number of required responses, and the timeframe for their response); and (3) indicating where the survey result data is to be sent; and (5) confirming the request and entering pertinent payment information.

To aid the client in developing questions (i.e., choose the appropriate question type for the particular issue to be addressed, etc.), the client is provided with helpful hints, guidelines, and examples. These helpful hints and guidelines are typically provided through the use of suggested question types that are frequently used in the field of market research. For example, in defining the survey the client may be provided with hints and guidelines for the phrasing of questions to limit bias and minimize the risk of offending network users, the proper ordering of questions to create a logical and easy-to-answer survey, etc.

By selecting a particular question type button, the client begins the question definition process. For example, in certain embodiments when the client selects the question type button (question type of “Agreement”), the client is presented with the introductory phrase:

“Using the scale below, please indicate how strongly you agree or disagree with the following statement: . . . ”

The client may then enter text to complete the question as desired. In certain embodiments, the client has the option to overwrite the entire introductory phrase to create their own custom question.

After the client has completed the question, they are then presented with appropriate responses relevant to the selected question type. For example, in selecting the response button for the response type “Agreement,” the client is presented with the following default responses: (i) Strongly Agree; (ii) Agree; (iii) Neither Agree nor Disagree; (iv) Disagree; (v) Strongly Disagree; and (vi) Don't Know.

In certain embodiments, the client can add, delete, or change one or more of the default responses associated with a particular question type as deemed appropriate by the client. For example, the client may decide to change the response (iii) from “Neither Agree nor Disagree” to “Neutral,” or simply delete the response (vi) “Don't Know.”

In certain embodiments, clients can select the structure and presentation of questions to network users. A box enables the client to interact with the interface to create a single question or a “table” of questions. If the client enters a value of 1 for “Number of Items” in box, a single question is created.

If the client enters a value greater than 1 in a box, a “table” with the specified number of items can be created and presented to network users. Tables enable network users to efficiently review and answer multiple items, reducing the amount of time and effort required to complete a set of questions or survey.

By selecting the value in the box, clients may choose the presentation format of a question. Enabling clients to select presentation formats makes surveys more versatile, user-friendly, and interesting for network users.

In certain embodiments, the client may include “branching” in defining the survey. The inclusion of branching in the survey allows for a different survey question to be presented based on previous response(s).

At any point while the client is defining the survey, the client has the option of editing, changing, adding, deleting, or reordering any of the previously entered questions, question types, or responses. Reordering enables the client to alter the sequence of questions within the survey, potentially providing a more logical flow within the survey or improving the quality of data provided by network users to eliminate bias or other influences that may adversely affect the survey results.

Clients have the ability to add multiple questions, one after the other, to define the survey. To help the client correctly define the survey, a “View Survey” option is contained on an interface that is provided to the client which allows the client to view how the completed survey will appear to a network user. In certain embodiments, the client can include graphical representations in defining the survey. For example, to enhance the appearance of the survey, the client may include pictures, drawings, sound, and animations. In certain embodiments, clients may include sound, video, or other “objects” that may engage network users or facilitate communication and interaction with network users.

Clients may develop and save multiple surveys. Each survey may be identified and named by the client. The definition and content of each survey may be maintained persistently across client invocations or log-ins. Furthermore, existing surveys or parts of surveys may be copied, renamed, or modified to create new surveys—expediting the survey development process for experienced clients.

Selecting a Target Group

Once the client is satisfied with the developed survey, a target group of network users or fielding the survey preferably can be selected or may be self-selected by member users. In one embodiment, to aid the client in selecting the appropriate target group, the client is provided with a list of predefined target or network user groups.

In addition to the above examples, member demographic, lifestyle, behavioral, and interest groups data may be available to clients for selection and survey targeting.

For the survey to be fielded, the client must specify the number of completed surveys they require (i.e. the number of network users who complete the survey) and the timeframe for obtaining those completed surveys. In certain embodiments, the client is provided with a default or suggested number of completed surveys and timeframes. In one embodiment, the default or suggested number of completed surveys is based on the number of completed surveys that is typically requested or required in the field of market research.

In certain embodiments, the client is able to define a particular duration that the survey is to be “in the field.” For example, the client may specify that the survey is to be fielded for two weeks. In another embodiment, the client may use a combination of completed surveys and duration to define how long the survey is to field. For example, the client may request that the survey field for six months or until 10,000 responses are received.

Providing Survey Result Data to the Client

When a survey is fielded to a particular member target group, the results are gathered, processed, and analyzed to generate survey data that reflects the survey results. To enable the delivery of the survey data, the interface allows the client to specify an address for receiving the survey data. Using the specified address, the survey data may be provided to the client in a variety of formats. In one embodiment, the survey results are provided to the client in spreadsheet formats that include automated data processing, analyzing, and charting scripts, software, or computer instructions.

In addition to delivering results, in certain embodiments, the client is provided with or allowed to access real-time results (i.e. information about the completed surveys received thus far). In one embodiment, real-time survey data is posted on a site connected to the network system that is accessible by the client.

Generating the Survey

After a client agrees to the terms and conditions associated with using the automatic survey mechanism, the automated survey mechanism determines the particular location (controlled by the automated survey system) where the survey will reside on the network. The automated survey mechanism then generates a survey based on the information (survey definition) supplied by the client and places it at the identified location. In certain embodiments, the generated survey consists of one or more HTML pages that are accessible over the Internet or Intranets to network users wanting to take the survey.

In addition to generating and storing the survey, the automated survey mechanism generates response validation rules that are automatically enforced. These rules provide a mechanism for validating the responses from network users input as they participate in a survey. In certain embodiments, the response validation rules are linked to the survey to ensure the data provided by a network user is logically valid and consistent with questions in the survey. The response validation rules can be used to increase the quality of the survey data that is provided to the client. In certain embodiments, errors or logical inconsistencies that are identified are reported to the network user thus enabling them to take correct action (i.e. enter valid information).

Additionally, the automated survey mechanism identifies and designates a specific storage unit for storing survey results. A storage unit is linked to each survey and is used to automatically capture survey results from network users who participate in the survey. In certain embodiments a unique storage unit is used to store the results for a particular survey. For example, when a survey is generated, a unique storage unit is identified and attached to the survey such that the results from a network user completing the survey are automatically stored into the unique storage unit. In certain embodiments, the storage unit is a database that can be used to store the survey results that were generated by participating network users.

Fielding the Survey and Launching a Banner

To attract network users of the desired target group to participate in the survey, the automated survey mechanism, in one preferred embodiment, causes a banner or other recruitment device to be placed, launched, or made available for viewing on one or more sites on the network system. In certain embodiments, the particular sites for viewing a banner associated with a particular survey are selected based on the target group information that was previously supplied by the client.

In one embodiment, the automated survey mechanism maintains a static mapping between banner locations and targeted groups. The automated survey mechanism uses this static mapping to identify one or more locations for launching a banner on the network system.

In certain embodiments, a dynamic mapping between target groups and network users is performed by (1) acquiring data that identifies a network user (i.e., name, social security number, etc.), (2) locating within an information repository or database prior information that was obtain about the network user, (3) determining a target group to which the network user belongs based on the information in the repository, and (4) delivering to the network user a Web page that has a banner for a survey targeted to a group to which the network user belongs.

Banners can either be statically or dynamically created. In one embodiment, the automatic survey mechanism dynamically creates a particular banner using the target group information that was supplied by the client while defining the survey. The automated survey mechanism then requests the owner of the identified site(s) to launch the dynamically created banner.

In one embodiment, the automated survey mechanism causes a static or predefined banner to be launched at the identified site(s). The static or predefined banner may be maintained by either the site owner(s) or by the automatic survey mechanism. In other embodiments, banners are launched by sending a message to the owner or representative of the identified site(s), requesting that a banner be launched.

Each banner that is launched contains a reference (e.g., hypertext link) to a corresponding survey. Thus, by selecting a particular banner, network users are automatically presented with a corresponding survey.

In certain embodiments, network users are requested to enter information about themselves (i.e., age, occupation, etc.) within the banner or recruiting document itself. Individual member demographic data is linked to the member ID and password. Using this information, a survey is dynamically identified and presented to the network user. By dynamically identifying a particular survey based on the attributes of a network user, an appropriate survey can be presented to the network user, thus potentially increasing the efficiency of the overall system.

In certain embodiments, the banner contains information that attempts to attract users of the network system to participate in the survey.

Because meaningful survey results typically require opinions from a non-biased population, the automatic survey mechanism attempts to prohibit network users from participating in a particular survey multiple times. In one embodiment, the automatic survey mechanism uses cookie information to identify computers that were previously used to complete a particular survey. For example, when a network user completes a survey, cookie information is stored on the computer that identifies the computer as one that has previously been used to participate in the particular survey. Thereafter, when a network user attempts to participate in a particular survey using the same computer, the network user is denied access to the survey. In an alternative embodiment, the automatic survey mechanism maintains previously entered participant information that can be used to identify network users who have previously completed a particular survey.

After the required number of completed surveys is obtained, or the duration for fielding the survey has expired, access to the survey is disabled. The owners of the sites where the corresponding banner was launched are notified that the banner should be removed. Upon receiving the notice, the owner removes the banner from the site or prevents the banner from being displayed, thus eliminating access to the survey by network users.

Gathering and Analyzing Survey Results

After a banner is launched, network users may click on the banner to participate in the survey. When a network user completes a survey, the results are automatically sent over the network system where they are validated and stored in a corresponding storage unit (e.g. database) using the validation and insertion commands that are attached to the survey.

Preferably, after each response a particular survey is inserted into the appropriate database, a counter for that particular survey is incremented. If the counter for the survey equals the number of responses requested by the client, the owner of the site on which the banner was launched is notified that the banner should be removed. The results are then processed and analyzed to generate survey data and charts reflecting the gathered survey results from self-selected audiences or a selected group. Processing and analysis of the collected data may include, for example, the extraction of the survey data from the database and the creation of cross-tabulations and graphical charts. Once the processing is complete, the survey data is sent to the address that was previously specified by the client while defining the survey.

In certain embodiments, survey results are analyzed on a periodic basis to generate real-time survey data. For example, in one embodiment, the automated survey mechanism generates real-time survey data by causing the survey results for a particular survey to be analyzed on a daily basis. The real-time survey data is then posted at a particular site on the network that can be accessed by the client. This allows the client to obtain survey data while the survey is still being fielded to users of the network system.

The Automated Survey Process

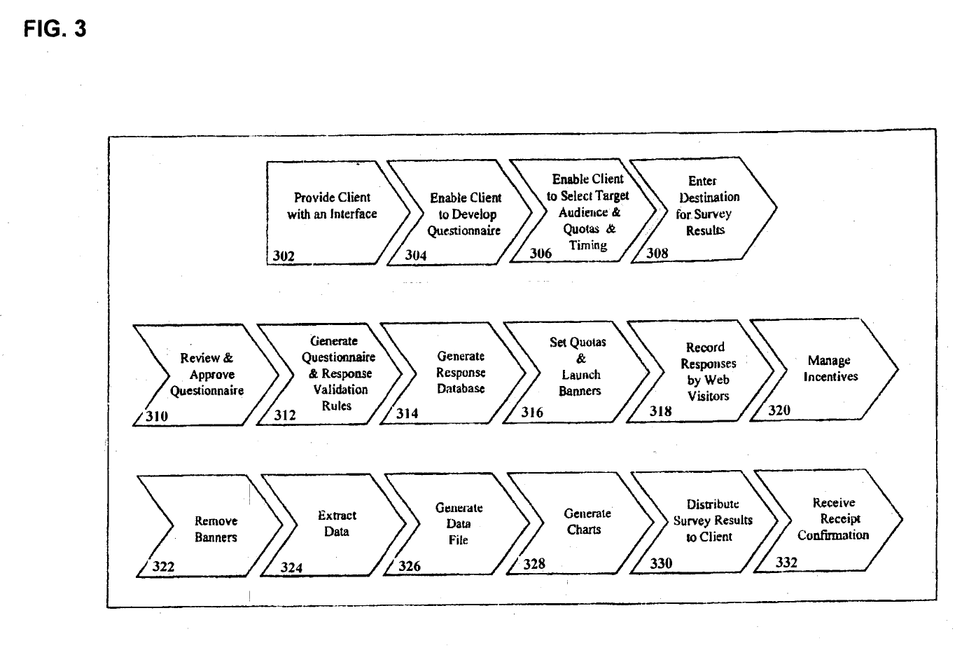

FIG. 3 illustrates a flow diagram for automating a survey over a network in accordance with an embodiment of the invention. At step 302, an automatic survey system generates interface data that defines an interface. The automatic survey system then causes the interface to be displayed on a client's display unit. At step 304, the client interacts with the interface to define a survey. By interacting with the interface, the client can define questions, select responses, edit, reorder, and view the survey.

At step 306, the client selects a target group of network users who are to take and complete the survey. During this step, the client also specifies the number of desired completed surveys and/or the duration the survey is to field.

At step 308, the client uses the interface to provide an address to define where the survey results are to be delivered.

At step 310, the survey created by the client is reviewed and screened for propriety. At step 312, the automated survey system generates a survey based on the parameters and data provided by the client. At this step, response validation rules and insertion commands are created and attached to the survey. At step 314, an information repository such as a database is created to store survey results from network users.

At step 316, quotas or the number of completed surveys requested by the client are attached to the database. The automatic survey mechanism then fields the survey by causing one or more banners to be launched, activated, or displayed on one or more sites on the network system.

At step 318, survey responses from network users participating in the survey are captured and inserted into the information repository or storage unit. At step 320, compensation or incentives are managed for network users who complete the survey.

At step 322, the banners are removed from the sites on the network system once the number of desired completed surveys has been achieved or a specified time period has elapsed. At this step, the automatic survey system sends messages to all appropriate sites indicating the banner should no longer be displayed.

At step 324, the survey results provided by network users are extracted from the storage device. At step 326, the extracted survey results are processed, analyzed, and formatted using common file formats. At step 328, graphical representations of the survey results are generated and inserted into the survey data file.

At step 330, the file containing the results of the survey is sent to the address that was previously provided by the client. At step 332, a receipt confirmation is received from the client indicating the file containing the survey results has been received.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A method for polling a group over a network system, the method comprising the steps of:
maintaining, on a computer readable medium, electronic information for use in constructing a poll;
causing an interface to be displayed at a particular client of said network system, wherein the interface allows a user of said particular client to respond to a poll and to provide demographic information;
after causing the interface to be displayed, and in response to a user interacting with said interface displayed at said particular client, the polling system automatically performing the steps of:
collecting poll responses and demographic information over said network system from said interface at a server that is remotely located from said client and generating therefrom a set of compiled statistics at said server; and
after generating the set of compiled statistics, delivering said set of compiled statistics to said particular client over said network system,
wherein participation in said poll is invited by causing one or more links to said poll to be embedded in said one or more target resources to allow users of said network to request participation in said poll by accessing one of said target resources over said network and activating said link in said one of said target resources.

2. The method for polling a group over a network system according to claim 1, wherein said set of compiled statistics delivered to said particular client over said network system is in a weighted format.

3. The method for polling a group over a network system according to claim 1, wherein said set of compiled statistics delivered to said particular client over said network system is in an unweighted format.

4. The method for polling a group over a network system according to claim 1, further comprising providing a message board forum in which one or more users of said particular client can communicate.

5. The method for polling a group over a network system according to claim 1, wherein participation in said poll is further invited by causing one or more links to educational resources regarding one or more issues concerning the poll are embedded in said one or more target resources to allow users of said network to seek information on said one or more issues by accessing one of said target resources over said network and activating said link in said one of said target resources.

6. The method for polling a group over a network system according to claim 5, wherein participation in said poll is further invited by causing one or more articles regarding one or more issues concerning the poll are embedded in said one or more target resources to allow users of said network to seek information on said one or more issues.

7. A computer-readable medium carrying one or more sequences of one or more instructions for providing an automated polling system over a network system, the one or more sequences of one or more instructions including instructions which, when executed by one or more processors, cause the one or more processors to perform the steps of:
maintaining, on a computer readable medium, electronic information for use in constructing a poll;
causing an interface to be displayed at a particular client of said network system, wherein the interface allows a user of said particular client to respond to a poll and to provide demographic information;
after causing the interface to be displayed, and in response to a user interacting with said interface displayed at said particular client, the polling system automatically performing the steps of:
collecting poll responses and demographic information over said network system from said interface at a server that is remotely located from said client and generating therefrom a set of compiled statistics at said server; and
after generating the set of compiled statistics, delivering said set of compiled statistics to said particular client over said network system,
wherein participation in said poll is invited by causing one or more links to said poll to be embedded in said one or more target resources to allow users of said network to request participation in said poll by accessing one of said target resources over said network and activating said link in said one of said target resources, and
wherein the one or more target resources are located at locations that are remote relative to said automated polling system and accessible to said automated polling system over said network system.

8. The computer-readable medium carrying one or more sequences of one or more instructions for providing an automated polling system over a network system according to claim 7, wherein said set of compiled statistics delivered to said particular client over said network system is in a weighted format.

9. The computer-readable medium carrying one or more sequences of one or more instructions for providing an automated polling system over a network system according to claim 7, wherein said set of compiled statistics delivered to said particular client over said network system is in an unweighted format.

10. The computer-readable medium carrying one or more sequences of one or more instructions for providing an automated polling system over a network system according to claim 7, further comprising providing a message board forum in which one or more users of said particular client can communicate.

11. The computer-readable medium carrying one or more sequences of one or more instructions for providing an automated polling system over a network system according to claim 7, wherein participation in said poll is further invited by causing one or more links to educational resources regarding one or more issues concerning the poll are embedded in said one or more target resources to allow users of said network to seek information on said one or more issues by accessing one of said target resources over said network and activating said link in said one of said target resources.

12. The method for polling a group over a network system according to claim 11, wherein participation in said poll is further invited by causing one or more articles regarding one or more issues concerning the poll are embedded in said one or more target resources to allow users of said network to seek information on said one or more issues.
